(19) United States
(12) Patent Application Publication
(10) Pub. No.: US 2011/0119820 A1
(43) Pub. Date: May 26, 2011

(54) GERM TRAPPING DEVICE AND METHOD OF USING THE GERM TRAPPING DEVICE

(75) Inventor: Peter C. Whittington, Plantation, FL (US)

(73) Assignee: SNOUGH, INC., Plantation, FL (US)

(21) Appl. No.: 12/890,128

(22) Filed: Sep. 24, 2010

Related U.S. Application Data
(60) Provisional application No. 61/263,024, filed on Nov. 20, 2009.

(51) Int. Cl. A61J 19/00

(52) U.S. Cl. 4/285

(57) ABSTRACT

A germ trapping device is constructed for preventing germs from spreading due to coughing or sneezing. The germ trapping device includes a receptacle having a closed position and an open position. The receptacle is made of a material hindering liquid from passing through the receptacle. The receptacle has an interior with a germicide. The receptacle has a plurality of biasing members biasing the front wall and the rear wall of the receptacle toward each other such that the receptacle is normally in the closed position. The method of using the device includes applying a force to the biasing members to move the front wall and the rear wall apart and to place the receptacle in the open position. When the receptacle in the open position, a person can sneeze or cough into the receptacle of the germ trapping device to prevent germs from spreading.

### CROSS-REFERENCE TO RELATED APPLICATION

This application claims the priority, under 35 U.S.C. §119(e) of provisional patent application No. 61/263,024, filed on Nov. 20, 2009.

### BACKGROUND OF THE INVENTION

1. Field of the Invention

The invention relates to a germ trapping device and to a method of using the germ trapping device to prevent germs, which are emitted into the air from a person that is coughing or sneezing, from spreading to one or more people in the vicinity of the person that is coughing or sneezing.

2. Description of the Related Art

People typically cough or sneeze into their hands in an effort to prevent the germs that are expelled from their respiratory tracts during coughing or sneezing from spreading throughout the air and infecting other people that are located nearby.

### BRIEF SUMMARY OF THE INVENTION

It is an object of the invention to provide a germ trapping device that can be used by a person to more effectively prevent the germs, which are expelled from that person's respiratory tract during sneezing or coughing, from spreading throughout the air and infecting other people that are located nearby.

With the foregoing and other objects in view there is provided, in accordance with the invention, a germ trapping device including a receptacle having a closed position and an open position. The receptacle is made of a material hindering liquid from passing through the receptacle. The receptacle has an interior with a germicide.

In accordance with an added feature of the invention, the receptacle includes a pair of opposing walls and a plurality of biasing members that bias the walls of the receptacle toward each other such that the receptacle is normally in the closed position.

In accordance with an additional feature of the invention, the pair of opposing walls includes a front wall and a rear wall, and the rear wall has a sealing portion that seals the receptacle when folded over the front wall.

In accordance with another feature of the invention, the receptacle includes a pair of opposing walls and carbon disposed in the walls to absorb odors, dust and bacteria.

In accordance with a further feature of the invention, the material allows air to pass through the receptacle.

In accordance with a further added feature of the invention, the material is fabric.

In accordance with another added feature of the invention, the material is impermeable to liquid and permeable to air.

With the foregoing and other objects in view there is also provided, in accordance with the invention, a method of using a germ trapping device to prevent germs from spreading due to coughing or sneezing. The method includes steps of: providing a germ trapping device including a receptacle having a closed position and an open position, and making the receptacle of a material hindering liquid from passing through the receptacle; and placing the receptacle into the open position and sneezing or coughing into the receptacle of the germ trapping device to prevent germs from spreading.

In accordance with an added feature of the invention, the method includes: providing the receptacle with a pair of opposing walls and a plurality of biasing members biasing the walls toward each other such that the receptacle is normally in the closed position; and performing the step of placing the receptacle into the open position by applying a force to the biasing members to move the front wall and the rear wall apart.

In accordance with an additional feature of the invention, the method includes a step of: after performing the step of sneezing or coughing into the receptacle of the germ trapping device, folding the sealing portion of the rear wall over the top of the front wall to seal the receptacle.

In accordance with another feature of the invention, the method includes disposing carbon in the walls to absorb odors, dust and bacteria.

In accordance with a further feature of the invention, the method includes choosing the material such that the material allows air to pass through the receptacle.

In accordance with a further added feature of the invention, the method includes using a fabric as the material.

In accordance with a further additional feature of the invention, the method includes choosing the material to be impermeable to liquid and permeable to air.

In accordance with yet another feature of the invention, the method includes a step of providing the receptacle with an interior having a germicide.

With the foregoing and other objects in view there is provided, in accordance with the invention, a method of using a germ trapping device to prevent germs from spreading due to coughing or sneezing. The method includes steps of: providing a germ trapping device including a receptacle having a closed position and an open position, making the receptacle of a material hindering liquid from passing through the receptacle, and providing the receptacle with an interior having a germicide; providing the receptacle with a front wall having a top, a rear wall having a sealing portion, and a plurality of biasing members biasing the front wall and the rear wall toward each other such that the receptacle is normally in the closed position; and applying a force to the biasing members to move the front wall and the rear wall apart and place the receptacle in the open position, and sneezing or coughing into the receptacle of the germ trapping device to prevent germs from spreading.

With the foregoing and other objects in view there is provided, in accordance with the invention, a germ trapping device including a receptacle having a closed position and an open position. The receptacle is made of a fabric material that hinders liquid from passing through the receptacle. The receptacle has an interior with a germicide. The receptacle includes a pair of opposing walls and a plurality of biasing members that bias the walls of the receptacle toward each other such that the receptacle is normally in the closed position.

Other features which are considered as characteristic for the invention are set forth in the appended claims.

Although the invention is illustrated and described herein as embodied in a germ trapping device and in a method of using the germ trapping device, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a side view showing a person and a germ trapping device;

FIG. 2 is a plan view showing the germ trapping device with the receptacle in the open position;

FIG. 3 is a side view showing the germ trapping device with the receptacle in the closed position;

FIG. 4 is a view of the germ trapping device from the side opposite that shown in FIG. 3;

FIG. 5 is a schematic diagram of an example of a wall of the receptacle; and

FIG. 6 shows the germ trapping device in which a sealing portion is folded to seal the receptacle.

### DESCRIPTION OF THE PREFERRED EMBODIMENTS OF THE INVENTION

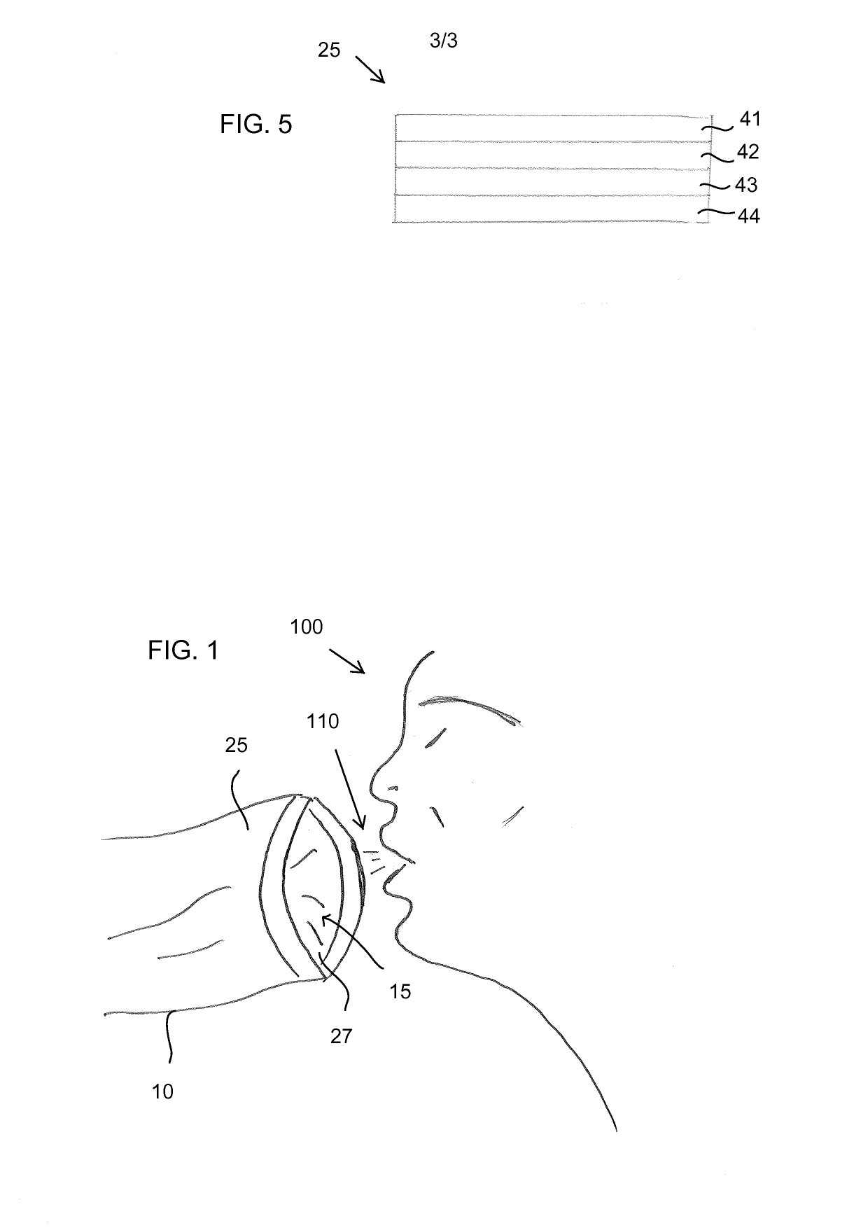

Referring now to the figures of the drawing in detail and first, particularly, to FIG. 1 thereof, there is shown a view of a person 100 expelling or emitting germs 110 into the receptacle 15 of a germ trapping device 10 during a sneeze or cough. The receptacle 15 has an open position as shown in FIGS. 1 and 2.

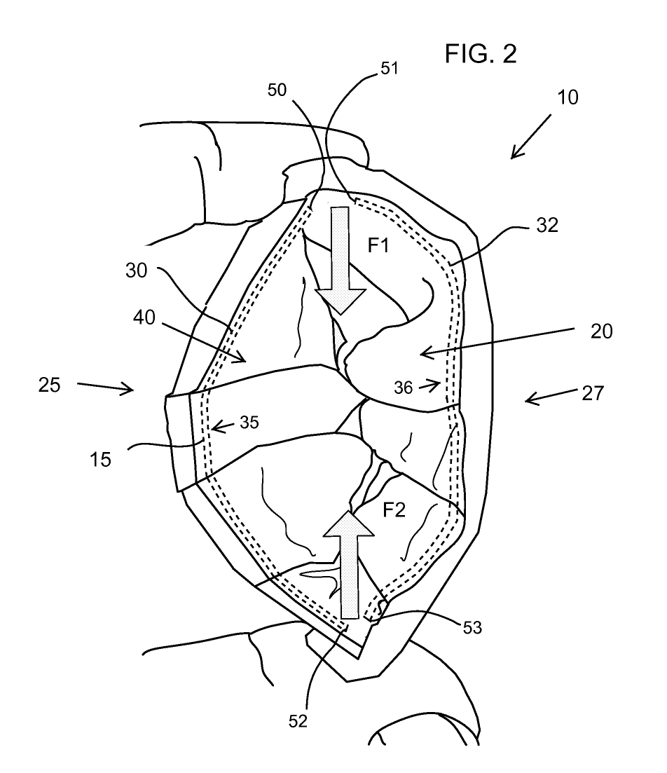

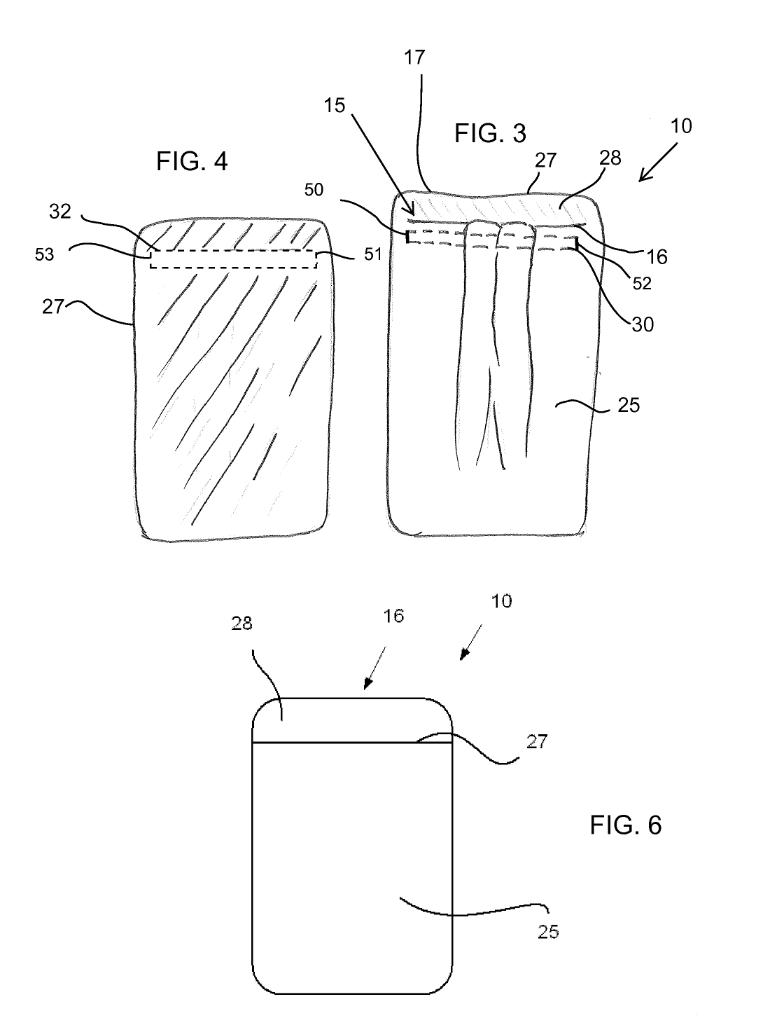

FIG. 3 is a side view showing the receptacle 15 of the germ trapping device 10 in the closed position. The receptacle 15 has a first or front wall 25 that can clearly be seen in FIG. 3. FIG. 4 is a view of the germ trapping device 10 from the opposite side in which a second or rear wall 27 that is opposite the front wall 25 can be seen. FIG. 3 shows that the rear wall 27 extends higher than the front wall 25. FIG. 3 shows the top 16 of the front wall 25 and the top 17 of the rear wall 27. The top 16 of the front wall 25 and the top 17 of the rear wall 27 define the opening of the receptacle 15 when the receptacle 15 is in the open position.

A first biasing member 30 is disposed in the front wall 25 and is depicted using a dotted line in FIG. 3. A second biasing member 32 is disposed in the rear wall 27 and is depicted using a dotted line in FIG. 4. The biasing members 30 and 32 are flexible, but remain straight when uninfluenced by an externally applied force. If a person is not applying an external force to the ends 50 and 52 of the biasing member 30 and to the ends 51 and 53 of the biasing member 32, the biasing members 30 and 32 keep the front wall 25 and the rear wall 27 flat and against each other such that the front wall 25 and the rear wall 27 keep the receptacle 15 in the closed position. In the closed position, the germ trapping device 10 will have substantially flat dimensions and can be easily carried by a person, for example, in a pocket, purse, backpack, or other type of carrying bag. In FIGS. 3 and 4, an external force is not applied and the receptacle 15 is in the closed position.

FIG. 2 shows a person applying inward forces F1 and F2 to the outer ends 51, 52, 53, and 54 of the biasing members 30, 32. The inward forces F1 and F2 are preferably applied using the fingers of one hand. However, both hands can be used to apply the inward forces F1 and F2. The applied inward forces F1 and F2 cause the middle portion 35 of the flexible biasing member 30 to move away from the middle portion 36 of the flexible biasing member 32. Naturally, this moves the front wall 25 away from the rear wall 27 and positions the walls 25, 27 such that the receptacle 15 is in the open position. While the person applies the inward forces F1 and F2 to hold the walls 25 and 27 away from each other such that the receptacle 15 is in the open position, the person will also hold the germ trapping device 10 in front of his/her mouth and cough or sneeze into the receptacle 15, which is in the open position.

The walls 25, 27 of the receptacle 15 are preferably made of a material 20 that hinders liquid from passing through the material 20. The material 20 is at least partially impermeable to liquid so that when a person holds the germ trapping device 10 in front of their mouth and coughs or sneezes into the receptacle 15, the liquid that is discharged from the person's respiratory tract and that contains germs that could infect another person located nearby, is hindered from passing through the material 20. However, the material 20 is preferably substantially impermeable to liquid to prevent, as much as possible, the liquid that is discharged from the person's respiratory tract from passing through the material 20.

The material 20 preferably allows air to pass therethrough so that the air being expelled from the person's respiratory tract is not reflected back into the person's face. Therefore it is also preferred that the material 20 is at least partially, and is preferably substantially permeable to air so that the air, which is emitted from the person's respiratory tract, will travel through the material 20. This will allow the emitted air, at least to some extent, to pass through the material 20 rather than being reflected back into the person's face.

The interior side of the wall 25 and the interior side of the wall 27 is preferably coated with a germicide 40, which is shown in FIG. 2. The germicide 40 may be a pharmaceutical agent or a natural substance. One example of a natural germicide is a combination of tea tree oil, peppermint oil, lemon juice, menthol crystals and vinegar. After sneezing or coughing into the receptacle 15, a person can remove the applied force F1, F2 to allow the biasing members 30, 32 to bias the walls 25, 27 of the receptacle 15 into the closed position. The person can then fold the sealing portion 28 of the rear wall 27 over the top 16 of the front wall 25 and onto the surface of the front wall 25 in order to seal the receptacle 15. The sealing portion 28, which is best seen in FIG. 3, is the portion of the rear wall 27 that extends from the top 17 of the rear wall 27 to the top 16 of the front wall 25. FIG. 6 shows the germ trapping device 10 in which the sealing portion 28 has been folded over the top 16 of the front wall 25 to seal the receptacle 15.

FIG. 5 is a schematic diagram of an example of a wall 25 that is constructed in multiple layers as a four layer system. The other wall 27 could be constructed in the same way as wall 25. The first or innermost layer 41 of each wall 25, 27 could be constructed from a soft nonwoven fabric layer. The next or second layer 42 could be constructed as a filter layer to filter out bacteria. This filter layer preferably has bacteria filtration efficiency that is rather high, for example, 99%. The third layer 43 could be a layer that includes carbon to absorb odors, dust, and bacteria. The fourth layer 44, which is the outermost layer, is constructed to provide stability to each wall 25, 27.

The walls 25, 27 may also act to muffle the sound caused by coughing or sneezing when the walls 25, 27 are held close to the face and the person coughs or sneezes into the receptacle 15. The germ trapping device 10 could be used in any location where it is desirable to prevent germs from being transmitted to other people. Such locations include, for example, hospitals, airplanes, health clinics, schools, and many other public places.

I claim:

1. A germ trapping device comprising: a receptacle having a closed position and an open position; said receptacle made of a material hindering liquid from passing through said receptacle, said receptacle having an interior with a germicide.

2. The germ trapping device according to claim 1, wherein said receptacle includes a pair of opposing walls and a plurality of biasing members that bias said walls of said receptacle toward each other such that said receptacle is normally in the closed position.

3. The germ trapping device according to claim 2, wherein said pair of opposing walls includes a front wall and a rear wall; and said rear wall has a sealing portion that seals said receptacle when folded over said front wall.

4. The germ trapping device according to claim 1, wherein said receptacle includes a pair of opposing walls and carbon disposed in said walls to absorb odors, dust and bacteria.

5. The germ trapping device according to claim 1, wherein said material allows air to pass through said receptacle.

6. The germ trapping device according to claim 1, wherein said material is fabric.

7. The germ trapping device according to claim 1, wherein said material is impermeable to liquid and permeable to air.

8. A method of using a germ trapping device to prevent germs from spreading due to coughing or sneezing, the method which comprises:
providing a germ trapping device including a receptacle having a closed position and an open position, and making the receptacle of a material hindering liquid from passing through the receptacle; and
placing the receptacle into the open position and sneezing or coughing into the receptacle of the germ trapping device to prevent germs from spreading.

9. The method according to claim 8, which comprises:
providing the receptacle with a pair of opposing walls and a plurality of biasing members biasing the walls toward each other such that the receptacle is normally in the closed position; and
performing the step of placing the receptacle into the open position by applying a force to the biasing members to move the front wall and the rear wall apart.

10. The method according to claim 9, wherein the pair of opposing walls includes a front wall that has a top and a rear wall that has a sealing portion; and which further comprises:
after performing the step of sneezing or coughing into the receptacle of the germ trapping device, folding the sealing portion of the rear wall over the top of the front wall to seal the receptacle.

11. The method according to claim 9, which comprises disposing carbon in the walls to absorb odors, dust and bacteria.

12. The method according to claim 8, wherein the material allows air to pass through the receptacle.

13. The method according to claim 8, wherein the material is fabric.

14. The method according to claim 8, wherein the material is impermeable to liquid and permeable to air.

15. The method according to claim 8, which comprises providing the receptacle with an interior having a germicide.

16. A germ trapping device comprising:
a receptacle having a closed position and an open position;
said receptacle made of a fabric material hindering liquid from passing through said receptacle, said receptacle having an interior with a germicide; and
said receptacle including a pair of opposing walls and a plurality of biasing members biasing said walls of said receptacle toward each other such that said receptacle is normally in the closed position.
